(19) United States
(12) Patent Application Publication
(10) Pub. No.: US 2012/0055307 A1
(43) Pub. Date: Mar. 8, 2012

(54) Table Saw Having a Removable Face Fence

(76) Inventors: Jeremy J. Burke, Sherwood, OR (US); Craig A. Carroll, Milan, TN (US); Peter Chaikowsky, Forest Hill, MD (US)

(21) Appl. No.: 13/222,010

(22) Filed: Aug. 31, 2011

Related U.S. Application Data
(60) Provisional application No. 61/379,603, filed on Sep. 2, 2010.

(51) Int. Cl. B27B 27/08; B23D 47/02; B23D 45/06

(52) U.S. Cl. 83/446

(57) ABSTRACT

A table saw fence having a guide rail, a fence beam having a front portion and a rear portion, and a fence face disposed adjacent to the fence beam. The fence face is movable along its longitudinal axis relative to the fence beam. A fence face locking mechanism is provided for locking the fence face relative to the fence beam. The locking mechanism has a handle disposed on the front portion of the fence beam and is movable between a first position where the fence face is locked relative to the fence beam and a second position where the fence is unlocked relative to the fence beam.

### CROSS-REFERENCE TO RELATED APPLICATIONS

This claims the benefit of U.S. Provisional Application No. 61/379,603, filed on Aug. 2, 2010. The disclosure of the above application is incorporated herein by reference.

### FIELD OF THE INVENTION

The present invention relates to a table saw, and more particularly to a table saw having at least one removable fence face.

### BACKGROUND

Generally a table saw for cutting work pieces includes a table and a saw assembly. FIG. 1 depicts a conventional table saw 100. The table saw 100 includes an alignment system, which includes a rail 108 and a fence beam 104 having a fence face 102. The alignment system is slidably mounted to the support surface of the table saw 100 via the rail 108, which extends substantially perpendicular to the saw blade, so that the fence beam 104 is aligned parallel with the saw blade. The alignment system can be locked in place via a handle 114. The alignment system is used to secure the work piece on top of the table and can be locked in a desired position via the handle 106. The work piece is rested on top of the table against fence face 102.

In conventional table saws, the fence face 102 may be damaged as a result of frequent contact with the edges of the work piece. Also, depending on the type of work piece used, different types of fence faces (e.g., sacrificial fence faces, stop blocks for miter cuts, and other dedicated faces custom-made by the user) may be desirable. What is needed is an alignment system with a replaceable fence face.

FIGS. 2A and 2B depict a conventional table saw in which the alignment system includes a fence face 202 that is movably and removeably connected to a fence beam 204 via a locking mechanism in the form of fasteners 206. The end of each fastener 206 is screwed into a face lock 208, forming a T-shaped clamp fitted inside a grove 210 of the fence face 202. The fasteners 206 may be tightened to pull the face lock 208 against the fence face 202, thus securely locking the fence face 202 against the fence beam 204. Loosening the fasteners 206 releases the face lock 208 inside the groove 210, thus allowing the fence face 202 to removeably slide parallel to the fence beam 204. The replaceable face 212 of the fence face 202 may then be easily replaced as needed to meet the user's specific needs. However, while this arrangement allows the fence face 202 to be removed and replaced, it allows only a single fence face to be used with the fence beam 204.

### BRIEF DESCRIPTION OF THE DRAWINGS

FIG. 1 depicts a conventional table saw having an alignment system.

FIGS. 2A and 2B depict a conventional table saw in which the alignment system includes a single fence face that is movably and removeably connected to a fence beam via a set of fasteners.

FIGS. 3A-3E depict an alignment system having one or more fence locks, according to an embodiment of the invention.

FIGS. 4A-4B depict an alignment system having a lock knob, according to an alternative embodiment of the invention.

FIGS. 5A and 4B depict a rear pad arranged under a back portion of the fence beam, according to another aspect of the invention.

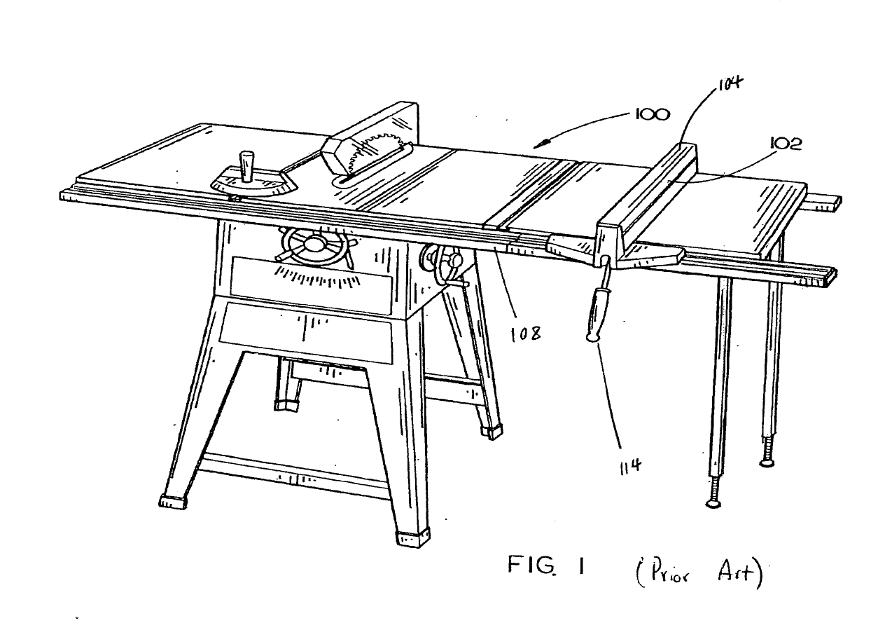

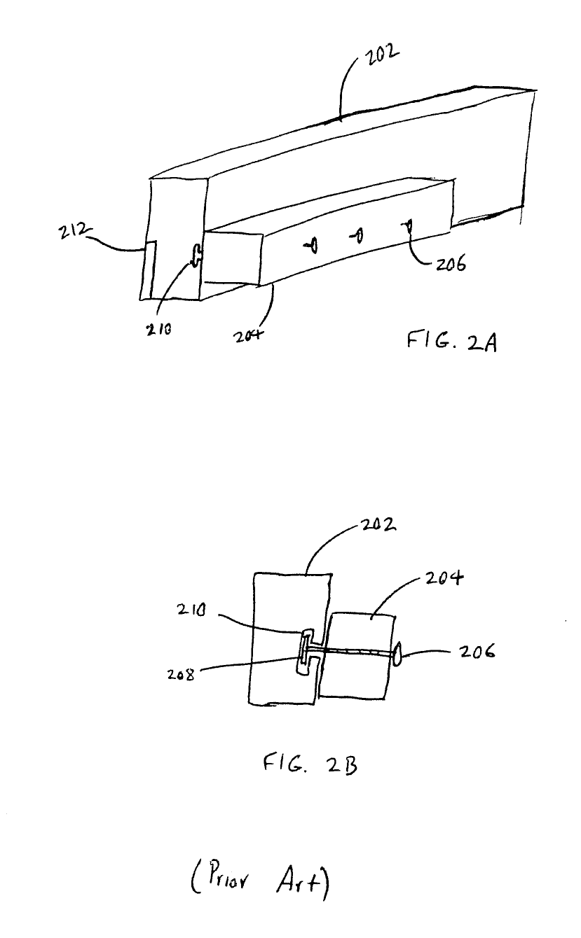

### DESCRIPTION

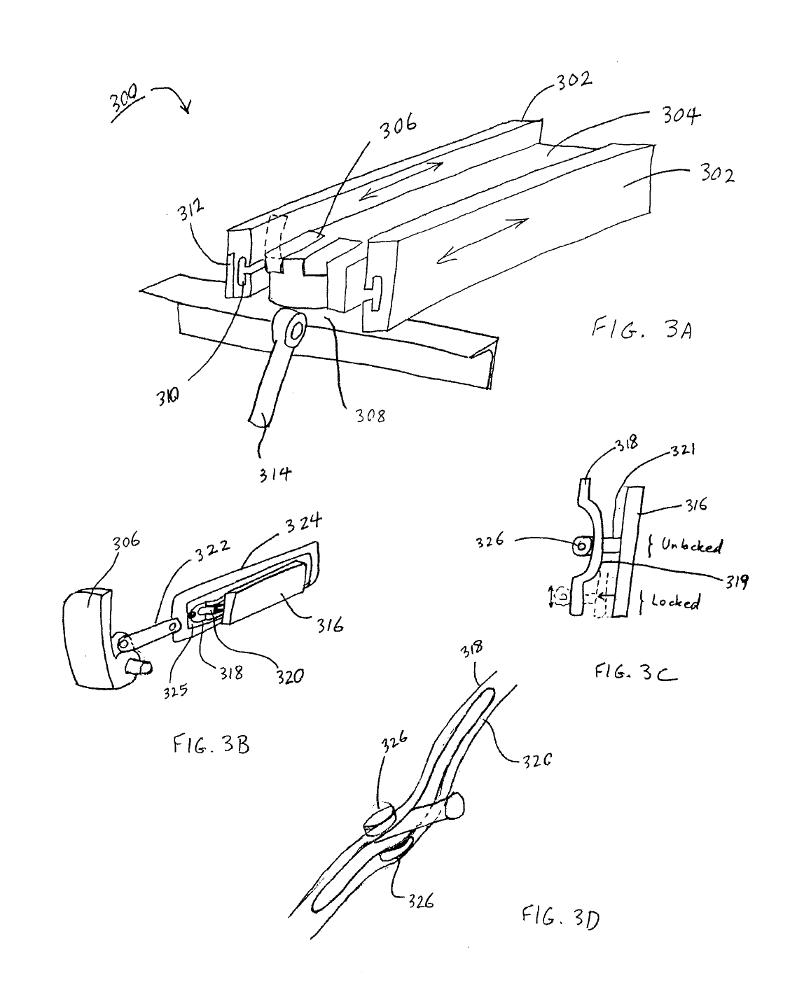

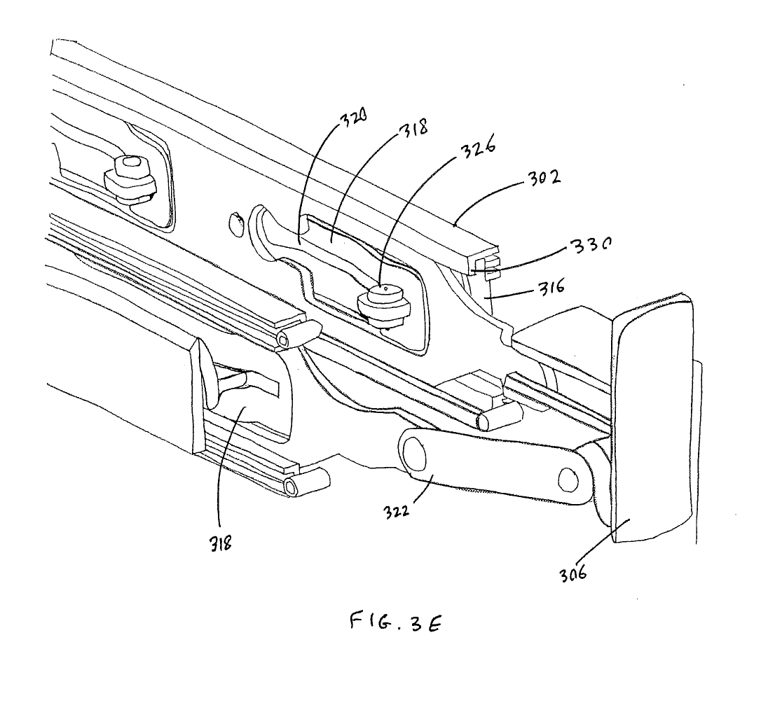

FIGS. 3A-3E depict an alignment system 300 according to an embodiment of the invention. The alignment system 300 includes two fence faces 302 and a fence beam 304. The alignment system 300 is slidably mounted to the support surface of the table saw via the guide rail 308, so that the fence beam 304 is aligned parallel with a saw blade arranged on the saw table. The alignment system can be locked in place via a handle 314, as is well known in the art.

As shown in FIG. 3A, the fence beam 304 includes two locking mechanisms. Each locking mechanism includes a face lock 306 located on an upper or front surface of the fence beam 304. Each fence face 302 includes a T-shaped groove 310 facing the fence beam 302. As described in detail below, pushing the face lock 306 down into a locked position (as depicted) forces a T-shaped clamp of the locking mechanism to engage an inner surface of the groove 310, thus locking the fence face 302 against the fence beam 304. Lifting the face lock 306 to an unlocked position will disengage the T-shaped clamp of the locking mechanism from the groove 310 and allow the fence face 302 to slide out of its position parallel to fence beam 304. The locking mechanisms operate independently. Thus, one of the fence faces 302 may be unlocked and replaced while the other is still locked to the fence beam 304.

FIG. 3B depicts the locking mechanism according to an embodiment of the invention. The locking mechanism includes a beam plate 324 attached to the face lock 306 via a link 322. The beam plate 324 is alideably disposed within the fence beam 304. Inside the beam plate 324 is a cavity 325, within which a roller plate 318 is fixed to the beam plate 324. The roller plate 318 itself includes an aperture 320.

As shown in FIGS. 3C and 3D, the locking mechanism includes a T-shaped clamp 321. The T-shaped clamp 321 includes a lock plate 316 arranged to engage the groove 310 of the fence face 302 on one end. The other end of the T-shaped clamp 321 is connected to at least one roller 326 through the aperture 320 to engage the back portion of the roller plate 318. The roller plate 318 includes a curved portion 319 curved towards the lock plate 316. In the unlocked position, the rollers 326 engage the curved portion of the roller plate 318, which loosens the lock plate 316 of the T-shaped clamp 321 inside the groove 310 of the fence face 302 (see FIG. 3A). This allows the fence face 302 to traverse freely parallel to the fence beam 304. Conversely, as the face lock 306 is pushed down to the locked position, the link 322 moves the beam plate 324 and the roller plate 318 relative to the lock plate 316. As the roller plate 318 is moved, the rollers 326 is forced to roll behind the uncurved portion of the roller plate 318, forcing the lock plate 316 of the T-shaped clamp 321 to come in contact with and press against an inner wall of the groove 310 of the fence face 302. The traction between the lock plate 316 and the inner wall of the groove 310 securely locks the fence face 302 against the fence beam 304.

FIG. 3E shows another view of the locking mechanism according to the above-described embodiment. As can be seen, the fence face 302 engages the fence beam 305 via a hook 330. The hook 330 limits the outward movement of the fence face 302 in the unlocked position. Accordingly, the fence face 302 can securely slide out in parallel to the fence beam 304 without wobbling.

Although the above-described embodiment discloses two fence faces 302, it will be understood by persons of ordinary skill in the art that the alignment system of the invention can be made using a single fence face 302. Also a single lock mechanism can be utilized to lock and/or unlock both fence faces 302. Furthermore, although a single curved portion of the roller plate 318 is depicted along with a single set of rollers 326 and a single T-shaped clamp, embodiments of the invention may be utilized using two or more curved portions engaging two or more sets of rollers 326 and two or more T-shaped clamps. Similarly, a single lock plate 316 may extend though the length of the fence face 302 or multiple lock plate 316 may be utilized.

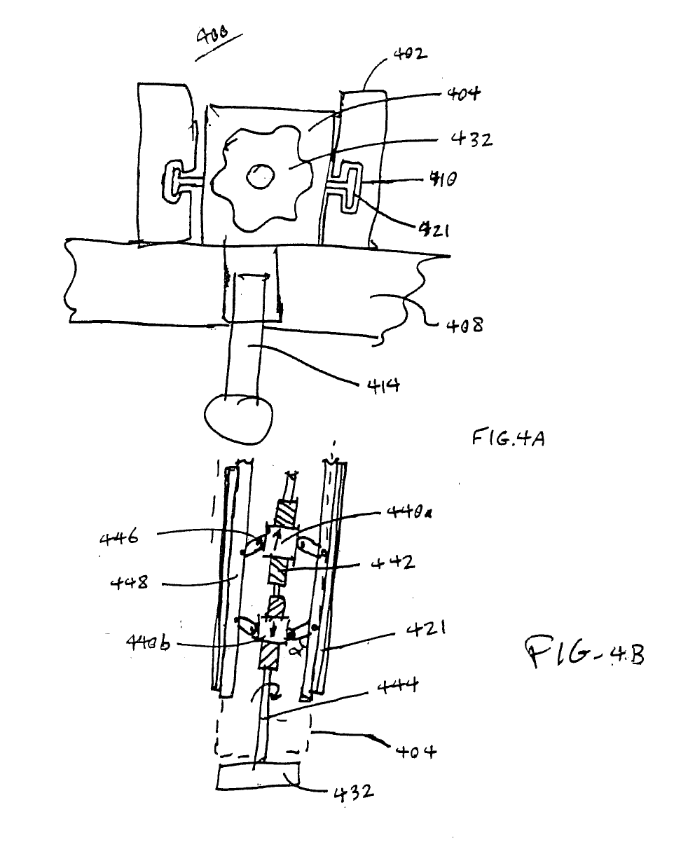

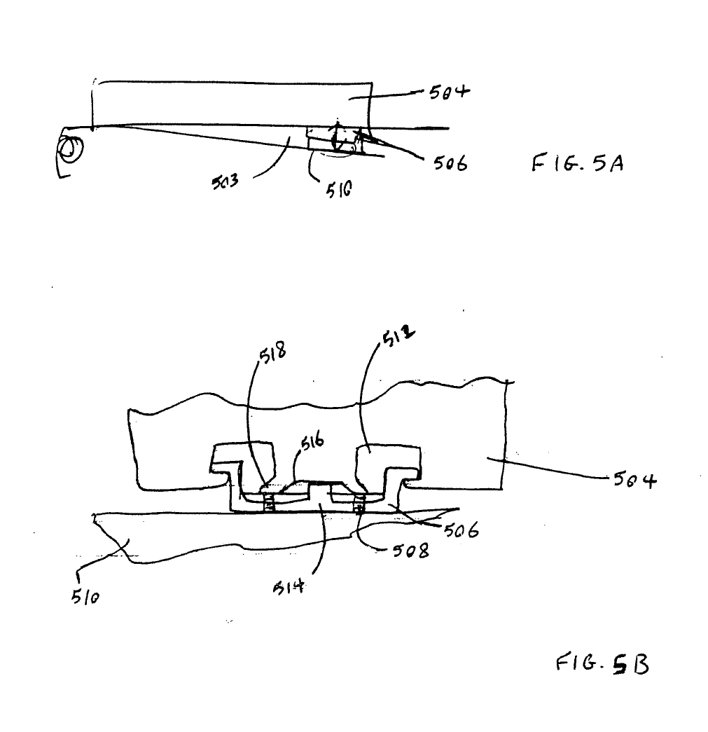

FIGS. 4A and 4B depict a locking mechanism according to an alternative embodiment of the invention. In this embodiment, as in the previous embodiment described with reference to FIGS. 3A-3E, the alignment system 400 includes a fence beam 404 and two fence faces 402. Also, a handle 414 is used to lock the alignment system 400 over the table saw having a rail 408. Instead of using fence locks and roller plates to lock the fence faces 402 described above, this embodiment utilizes a lock knob 432 arranged on a front face of the fence beam 404. Turning the lock knob 432 in one direction (e.g., clockwise) causes the T-shaped clamp 421 to press against an inner wall of the groove 410, thus locking the fence beam 404 against the fence face 402. Turning the lock knob 432 in the opposite direction (e.g., counter-clockwise) releases the T-shaped clamp 421 inside the groove 410, allowing the fence face 402 to slide out of position parallel to the fence beam 404.

As shown in FIG. 4B, the lock knob 432 is connected via a shaft 444 to one or more threaded regions 442. In the exemplary embodiment of FIG. 4B, the adjacent threaded regions 442 include oppositely-arranged threads, although the threaded regions may include threads in the same direction. A follower nut 440a, 440b is fastened on each threaded region 442. Each follower nuts 440a, 440b is attached on two ends to two links 446 of the T-shaped clamps 421. The links 446 are attached to a lock face 448 of the T-shaped clamp 421 at fixed positions.

Turning the lock knob 432 clockwise causes the threaded regions 442 to turn via the shaft 444. As the threaded regions 442 turn, the upper follower nuts 440a, 440b traverse in the longitudinal direction away from their original (unlocked) position. In this example, since the threaded regions 442 include oppositely-arranged threads, the follower nut 440a traverses away from the lock knob 432 and the lower follower nut 440b traversed towards the lock knob 432. As the follower nuts 440a, 440b move away from their original (unlocked) position, the acute angle α between the links 446 and the lock faces 448 becomes smaller, thus pulling the lock faces 448 closer towards the shaft 444. The lock faces 448 of the T-shaped clamps 421 thus press against the inner walls of the grooves 410 of the fence faces 402, locking the fence faces 402 against the fence beam 404.

In contrast, as the lock knob 432 is turned counter-clockwise, the follower nuts 440a, 440b move back to their unlocked position, the angle α becomes larger, and the lock faces 448 are pushed further away from the shaft 444. The lock faces 448 are thus loosened inside the groove 410, allowing the fence faces 402 to slidably move relative to the fence beam 404.

Another aspect of the invention is discussed herein with reference to FIGS. 5A and 5B. Generally, the top surface of table saws may include some unevenness, which would result in a gap between an end portion of the fence beam and the surface of the table. This gap may cause the end portion of the fence beam to become unstable. To overcome this problem, as shown in FIGS. 5A and 5B, a rear pad 506 is provided under the fence beam 504. The ends of the rear pad 506 are arch-shaped to fit inside cavities 512 of the fence beam 504. A middle portion of the rear pad 506 includes a projection 514 that fits inside a gap 516 between two protrusions 518 of the fence beam 504. The rear pad 506 additionally includes a number of set screws 508 used to adjust a height of the fence beam 504 relative to the end pad 504. Thus, the height of the rear pad may be adjusted depending on the size of the gap 503 between the end portion of the fence beam 504 and the table 510.

The description of the invention is merely exemplary in nature and, thus, variations that do not depart from the gist of the invention are intended to be within the scope of the invention. Such variations are not to be regarded as a departure from the scope of the invention.

What is claimed is:

1. A table saw fence comprising:
a guide rail disposed on a support surface of a table saw;
a fence beam having a front portion and a rear portion, the fence beam being connected to the guide rail at the front portion;
a fence face disposed adjacent to the fence beam, the fence face being movable along its longitudinal axis relative to the fence beam; and
a fence face locking mechanism for locking the fence face relative to the fence beam, the locking mechanism having a handle disposed on the front portion of the fence beam, the handle being movable between a first position where the fence face is locked relative to the fence beam and a second position where the fence is unlocked relative to the fence beam.

2. The table saw fence of claim 1, wherein the handle is rotatably movable between the first and second positions.

3. The table saw fence of claim 1, further comprising:
a lock plate extending out of the fence beam and extending into the fence face, the lock plate being movable between a first locking position and a second unlocking position; and
a beam plate slidably disposed within the fence beam and connected to the handle, the beam plate contacting the lock plate.

4. The table saw fence of claim 3, wherein the beam plate is slidable along its longitudinal axis.

5. The table saw fence of claim 3, wherein the beam plate moves the lock plate between the first locking position and the second unlocking position via contact therebetween.

6. The table saw fence of claim 3, wherein the lock plate has a T-shaped clamp disposed within a groove in the fence face.

7. The table saw fence of claim 3, wherein the lock plate has a roller contacting the beam plate.

8. The table saw fence of claim 7, wherein the beam plate has a non-planar contour followed by the roller.

9. The table saw fence of claim 1, further comprising:
a shaft connected to the handle;
a follower movably disposed on the shaft, the follower moving along a longitudinal axis of the shaft; and
a lock plate connected to the follower, the lock plate being movable between a first locking position and a second unlocking position via rotation of the handle.

10. The table saw fence of claim 9, wherein the follower is threadably engaged to the shaft.

11. The table saw fence of claim 9, wherein the lock plate has a T-shaped clamp disposed within a groove in the fence face.

12. The table saw fence of claim 1, further comprising a pad disposed underneath the fence beam at the rear portion, the pad being movable relative to the fence beam along a substantially horizontal direction.

13. A table saw comprising:
a table saw having a support surface; and
a fence being disposed on the support surface, the fence comprising:
a guide rail disposed on the support surface;
a fence beam having a front portion and a rear portion, the fence beam being connected to the guide rail at the front portion;
a fence face disposed adjacent to the fence beam, the fence face being movable along its longitudinal axis relative to the fence beam; and
a fence face locking mechanism for locking the fence face relative to the fence beam, the locking mechanism having a handle disposed on the front portion of the fence beam, the handle being movable between a first position where the fence face is locked relative to the fence beam and a second position where the fence is unlocked relative to the fence beam.

14. The table saw of claim 13, wherein the handle is rotatably movable between the first and second positions.

15. The table saw of claim 13, further comprising:
a lock plate extending out of the fence beam and extending into the fence face, the lock plate being movable between a first locking position and a second unlocking position; and
a beam plate slidably disposed within the fence beam and connected to the handle, the beam plate contacting the lock plate.

16. The table saw of claim 13, further comprising:
a shaft connected to the handle;
a follower movably disposed on the shaft, the follower moving along a longitudinal axis of the shaft; and
a lock plate connected to the follower, the lock plate being movable between a first locking position and a second unlocking position via rotation of the handle.

17. The table saw of claim 16, wherein the follower is threadably engaged to the shaft.

18. The table saw of claim 16, wherein the lock plate has a T-shaped clamp disposed within a groove in the fence face.

19. The table saw of claim 13, further comprising a pad disposed underneath the fence beam at the rear portion, the pad being movable relative to the fence beam along a substantially horizontal direction.
